(19) United States
(12) Patent Application Publication
(10) Pub. No.: US 2002/0096456 A1
(43) Pub. Date: Jul. 25, 2002

(54) Wastewater treatment system using cavitating waterjet

(76) Inventors: Wan-Mo Kim, Seoul (KR); Kwan-Mo Kim, Shiheung-city (KR)

Correspondence Address: Michael A. Cantor, 55 Griffin South Road, Bloomfield, CT, 06002, US

(21) Appl. No.: 10/054,309

(22) Filed: Nov. 12, 2001

(30) Foreign Application Priority Data
Nov. 11, 2000 (KR) 2000-0066965

(51) Int. Cl. B01D 35/14

(52) U.S. Cl. 210/90; 210/137; 210/205; 210/209; 210/259; 210/519

(57) ABSTRACT

Provided is a wastewater treatment system comprising a cavitation reactor including an inlet into which wastewater is introduced, a main body in which a cavitation reaction occurs to treat the water, and an outlet from which the treated water is discharged. The main body comprises a nozzle for ejecting the introduced water and a target with which the jetted water collide.

### BACKGROUND OF THE INVENTION

1. Field of the Invention

The present invention relates to a wastewater treatment system and method, and more particularly, to a cavitating waterjet system for wastewater treatment using fluid cavitation.

2. Description of the Related Art

Purification of water includes pre-treatment, filtration and sterilization. The pre-treatment generally includes screening, degritting, coagulation and precipitation. The sterilization includes addition of chlorine or sodium hypochlorate, ozone sterilization and UV irradiation.

However, the water purification, particularly filtration or sterilization of wastewater, has the following problems. When eutrophicated wastewater is filtered, the filtration speed may be decreased due to a filtering-prevention layer formed by viscous contaminants. Also, the chlorine sterilization may cause serious problems such as an unpleasant smell and toxicity owing to residual chlorine. In particular, in the course of sterilizing potable water and secondarily treating sewage, dissolved humic substances and fluoboric acid may react with chlorine to generate carcinogens such as trihalomethanes (THMs, for example chloroforms), causing seriously adverse effects, increasing the content of total dissolved solids in water to be treated and lowering the pH of the water in the case of insufficient alkali.

UV irradiation involves relatively high cost and requires sizable equipment. Ozone sterilization has several disadvantages including relatively high treatment cost, safety concerns, and high susceptibility to system operation and maintenance.

Also, it has been known that microorganisms such as viruses, spores or cysts are not killed at all even by addition of a small amount of chlorine or ozone or irradiation by low energy UV rays, like in coliform sterilization (see “Small and Decentralized Wastewater Management Systems” by Crites, R. & Tchobanoglous, G., McGraw-Hill, Singapore, 1998).

Parasites or coliforms, causing critical problems in fish hatcheries, breed such that their larvae incubate while suspended in water so that they are easily consumed or breathed in by fish. In order to remove the microorganisms, a large amount of formalin is used, which is prooved as a carcinogen and accordingly prohibited in major industrialized countries because it is a carcinogen. Also, in overcrowded fish-farms and hatcheries, lime is sprinkled into the water in order to prevent an increase in the amount of dissolved carbon dioxide and a decrease in pH level, which may cause fish to loose their scales or may cause damage to their internal organs.

In addition to sterilization of microorganisms in fish-farms and hatcheries, red tide microorganisms such as diatoms, flagellates and the like, frequently appearing in coastal areas and freshwater lakes in some countries every year, cause severe damage to fish-farms and hatcheries in the coastal areas and severely disturb/destroy the coastal ecosystem.

To minimize damage arising due to a red tide phenomenon, several techniques including sea-floor dredging, lime and loess sprinkling, sea-floor plowing, aeration and the like are used.

However, the sea-floor dredging technique for removing contaminants accumulated on the top layer of the sea-floor has several problems, including high cost and difficulty in application. Also, as described above, lime sprinkling, which causes fish to loose their scales or causes damage to their internal organs, facilitates decomposition of organic substances and prevents generation of hydrogen sulfide. For these reasons, lime sprinkling is used only for the purposes of suppressing eutrophication of seawater and production of marsh gas in seawater.

Also, loess sprinkling based on the principle that degradable organic contaminants and plankton in sea water are subject to coagulation, adsorption and sedimentation, is known to be capable of removing approximately 70% to approximately 80% of coclodinium and only a part of 14 other kinds of red tide microorganisms. However, according to this method, while sprinkled loess prevents dissolution of nutrient salts, it may clog the gills of fish, impeding respiration.

### SUMMARY OF THE INVENTION

It is therefore an object of the present invention to provide a wastewater treatment system and method which can decompose or destroy organic contaminants and aquatic microorganisms, without a reduction in filtering speed due to generation of a filtering-prevention layer, an unpleasant smell and toxicity arising due to residual chlorine, generation of carcinogens such as trihalomethanes (THMs), or a decrease in pH level, and secondary contamination.

To accomplish the above object, there is provided a wastewater treatment system including a cavitation reactor having an inlet into which wastewater is introduced, a main body in which a cavitation reaction occurs to treat the water, and an outlet from which the treated water is discharged, wherein the main body includes a nozzle for ejecting the introduced water and a target with which the jetted water collides.

The wastewater treatment system may further include a waterjet pump for pressurizing water and supplying the pressurized water to the inlet of the cavitation reactor.

Here, the waterjet pump is preferably either a plunger-type pump or an intensifier-type pump.

In the wastewater treatment system, the pressure of the water ejected from the waterjet pump is preferably maintained at 4 to 40 MPa.

Also, the wastewater treatment system may further include a first bypass throttle valve for bypassing a portion of the pressurized water to depressurize the pressurized water.

The wastewater treatment system may further include a first throttle valve for adjusting the amount of the pressurized water ejected from the waterjet pump and supplied to the inlet of the cavitation reactor.

Preferably, the wastewater treatment system further includes a filter for removing solid impurities larger than a predetermined size contained in the water.

The wastewater treatment system may further include a heat exchanger for maintaining the water at a predetermined temperature.

The wastewater treatment system may further include a second throttle valve for adjusting the amount of the water discharged from the outlet of the cavitation reactor.

The wastewater treatment system may further include a second bypass throttle valve for bypassing a portion of the pressurized water passed through the first throttle valve.

The wastewater treatment system may further include a third bypass throttle valve for controlling the pressure of the water discharged from the outlet of the cavitation reactor.

The wastewater treatment system may further include an accumulator for storing the water ejected from the waterjet pump to adjust the pressure of the same, between the waterjet pump and the first throttle valve.

The wastewater treatment system may further include a first pressure gauge for measuring the pressure of the water which flows into the inlet of the cavitation reactor.

The wastewater treatment system may further include a pressure adjusting means for adjusting the pressure of the water introduced into the inlet of the cavitation reactor to be maintained at 4 to 40 MPa.

In the wastewater treatment system, the pressure of water discharged from the outlet of the cavitation reactor is preferably adjusted to be maintained at 0.1 to 2.4 MPa.

The wastewater treatment system may further include a second pressure gauge for measuring the pressure of water discharged from the outlet of the cavitation reactor.

According to another aspect of the present invention, there is provided a wastewater treatment method including the step of provoking a cavitation reaction to treat wastewater ejected to a cavitation reactor having an inlet into which wastewater is introduced, a main body in which a cavitation reaction occurs to treat the water, and an outlet from which the treated water is discharged.

The wastewater treatment method may further include the step of pressurizing water, followed by the jetting step.

In the wastewater treatment method, the pressure of the water is preferably maintained at 4 to 40 MPa.

The wastewater treatment method may further include the step of removing solid impurities larger than a predetermined size contained in the water.

### BRIEF DESCRIPTION OF THE DRAWINGS

The above objects and advantages of the present invention will become more apparent by describing in detail preferred embodiments thereof with reference to the attached drawings in which:

FIG. 1 is a schematic diagram of a wastewater treatment system according to an embodiment of the present invention;

FIG. 2 is a cross-sectional view of a reactor having a cylindrical nozzle according to an embodiment of the present invention;

FIGS. 3A through 3H are cross-sectional views of nozzles having various shapes according to other embodiments of the present invention;

FIG. 4 is a graph showing the efficiency of removing dichlorophenol compounds for different numbers of circulations according to the present invention;

FIG. 5 is a graph showing the efficiency of removing polychlorobiphenyl for different circulation times according to the present invention;

FIG. 6 is a graph showing the efficiency of removing trichloroethylene for different circulation times according to the present invention; and

FIG. 7 is a graph showing the efficiency of sterilizing coliforms for different circulation times according to the present invention.

### DETAILED DESCRIPTION OF THE INVENTION

The present invention will now be described in more detail. The present invention is directed to wastewater treatment using cavitation and is characterized in that wastewater containing environmentally polluting organic substances and microorganisms is treated such that wastewater containing these contaminants is ejected into a cavitation reactor to be decomposed, oxidized and crushed using a high temperature of approximately 5,000° C., an ultrahigh pressure microjets of several GPa, and radicals, occurring around cavitation bubbles when the cavitation bubble collapse.

Residual chlorine injected during sterilization of potable water causes an unpleasant smell and toxicity and reacts with dissolved humic substances and fluoboric acid to generate carcinogens such as trihalomethanes (THMs), increases the content of total dissolved solids (TDS) of water to be treated and to lower the pH of the water. In the wastewater treatment according to the present invention, contaminants such as water microorganisms can be destroyed or decomposed using radicals, ultrahigh shock waves and ultrahigh-pressure microjets generated when cavitation bubbles collapse through strong oxidation, decomposition, erosion and cutting, just by ejecting wastewater into a cavitation reactor without using any additives.

Thus, problems such as an unpleasant smell, toxicity owing to residual chlorine, secondary contamination, generation of THMs or lowering of pH, do not arise at all. Rather, a decrease in the concentration of carbon dioxide, which is caused by generation of a cavitation bubble cloud, can increase the pH level. Also, high-viscous organic contaminants can be easily decomposed by the radicals, ultrahigh shock waves and ultrahigh-pressure microjets, thereby preventing the filtering speed decrease owing to the formation of a filtering-prevention layer.

It has been reported that e. coli bacteria, a kind of coliform, are not destroyed until plain waterjets are continuously jetted for 1 to 2 minutes with a pressure of 552 MPa. Also, it has been disclosed that heterobothnium's egg survives even at a chlorine concentration of approximately 50 ppm or higher or at a high pressure of approximately 600 MPa. However, use of an apparatus according to the present invention can make it possible to effectively destroy heterobothnium' egg at a relatively low pressure of 40 MPa or less.

As described above, according to the wastewater treatment method using cavitating jets, most organic contaminants and water microorganisms can be decomposed/sterilized safely and easily at relatively low cost compared to the conventional water purification method.

Also, various kinds of microorganisms including water parasites and coliforms and wastewater contaminated by organic substances such as carcinogens, fish-luring agents are altogether injected into a cavitation reactor to be indiscriminately destroyed and sterilized, without using a carcinogenic sterilizer, e.g., formalin, or other chemicals. Also, a decrease in the concentration of dissolved carbon dioxide due to generation of cavitation bubble clouds increases a pH level, so that lime needs not to be added. Therefore, the wastewater treatment method using cavitating jets according to the present invention is a clean technology that can effectively improve environments, for example, in which fish must survive without harming the fish.

Moreover, diatoms, flagellates, toxic plankton causing sitotoxism by poisoning shellfish and the like, or red tide microorganisms as well as water parasites and coliforms, these microorganisms causing severe damage in coastal areas and freshwater lakes in some countries every year, can be removed safely at relatively low cost compared to conventional techniques including sea-floor dredging, lime and loess sprinkling, sea-floor plowing, aeration and the like, without harming fish.

Cavitation, which is a main feature of the present invention, will now be briefly described.

There are two ways to vaporize a liquid: increasing the temperature of the liquid until it boils; and cavitation owing to the pressure decrease of the pressurized liquid to a vapor pressure, the latter being applied in the present invention.

In other words, the energy conversion law for an incompressible fluid can be expressed by the Bernoulli theorem represented by Formula 1:

$$\frac{{υ}^{2}}{2} + \frac{P}{ρ} + gz = constant \qquad 1$$

wherein υ denotes a fluid velocity, P denotes a fluid pressure, ρ denotes a fluid density, g denotes acceleration of gravity and z denotes height from the horizontal plane.

If the fluid velocity increases like in the case where water is pumped and ejected out, the fluid pressure is locally reduced to a saturated vapor pressure. In this case, a cavitation bubble cloud consisting of water molecules and incondensable air molecules is generated in the liquid. As the fluid pressure is diminished, the fluid velocity decreases, then each cavitation bubble undergoes a series of procedures of constriction, rebound and collapse, creating high pressure of several GPa and a high temperature of approximately up to 5,000° C., generating microjets in the collapsed bubbles and generating ultrahigh shock wavesand radicals isolated from the bubbles, such as hydroxyl or hydrogen peroxide, around the collapsed bubbles. Here, the radicals, ultrahigh shock waves and ultrahigh-pressure microjets generated around the bubbles act like a micro reactor to oxidize, decompose, erode and cut ambient molecules with a high temperature of approximately 5,000° C. and a pressure of several GPa. The microjets are several times more effective in oxidizing, decomposing, eroding and cutting than plain waterjets ejected into the air with equal jet power. The relative intensity of the cavitation bubble cloud is defined by cavitation number σ given by Formula 2:

$$σ = \frac{{P}_{2} - {P}_{v}}{{P}_{1} - {P}_{2}} \approx \frac{{P}_{2}}{{P}_{1}} \qquad 2$$

wherein P₁ denotes a ejected waterjet pressure or upstream pressure, P₂ denotes a discharged fluid pressure of a reactor or downstream pressure, and Pᵥ denotes a saturated vapor pressure of a fluid, in units of MPa.

The optimum conditions for generating a cavitation bubble cloud vary according to various parameters, including existence form of bubble nuclei, dissolved gas concentration, fluid pressure and velocity in a reactor, vapor pressure of a liquid, surface tension, coefficient of kinematic viscosity, compressibility, specific heat, heat transfer, latent heat, turbulence, a sufficient time for growth of cavitation bubbles and so on, and the cavitation number σ is generally in the range of 0.01 to 0.06.

Now, potable water purification, sterilization and control of water quality in a hatchery and red tide reduction performed by an apparatus of the present invention utilizing cavitation will be described in detail.

The present invention is a new technique by which a variety of environmentally polluting organic substances and aquatic microorganisms such as viruses, coliforms and other algae, which are dispersed and dissolved in water, can be effectively removed through oxidation, decomposition, erosion and cutting using radicals, ultrahigh temperature and ultrahigh-pressure microjets by ejecting only wastewater into a reactor without using any additives.

In particular, over the past century, cavitation damage has been serious problem resulting in deterioration in performance, inner surface erosion, and noise or vibration in hydraulic devices and equipment such as pumps, hydraulic turbines and propellers, valves, fluid dynamometers and couplings, cylinder liners of diesel engines, fuel supplies and so on in various fields of applied fluid dynamics including marine engineering, aeronautical engineering and mechanical engineering. Currently, techniques for suppressing or reducing the above-noted problems are being developed worldwide.

In several industrialized countries, intensive research and development is underway using various physicochemical effects accompanied by cavitation, in extensive areas such as basic technology for improvement and processing of surface properties of semiconductors, metallic or ceramic materials, or sonochemistry applied areas including medicine, organic/polymer chemistry, electrochemistry, ultrasonic catalyst chemistry. Also, efforts are being made to improve air jet type or waterjet type industrial cleaning equipment by cavitating jet that is partially commercially available, in marine and construction sector.

Generation of cavitation bubble, which is seen to hold great promise as a practical technology in many industrial fields, is largely classified into two ways, namely, induced ultrasonic wave generation method and a cavitation waterjetting method. The former method has a limit in making large-capacity cavitation bubble generators, and is mainly adopted in development and production of cleaning apparatuses.

In the present invention, the latter method, that is, the cavitation watterjetting method, is applied to a wastewater treatment system, including a relatively low-pressure, large-flow plunger pump, and an improved Lichtarowicz cell-type reactor.

In the case of a closed circulating water reservoir, since the concentration of dissolved oxygen may be reduced by approximately 12% to approximately 14% for one hour, which may affect generation of cavitation bubble clouds, aerator may be further installed for the purpose of replenishing dissolved oxygen.

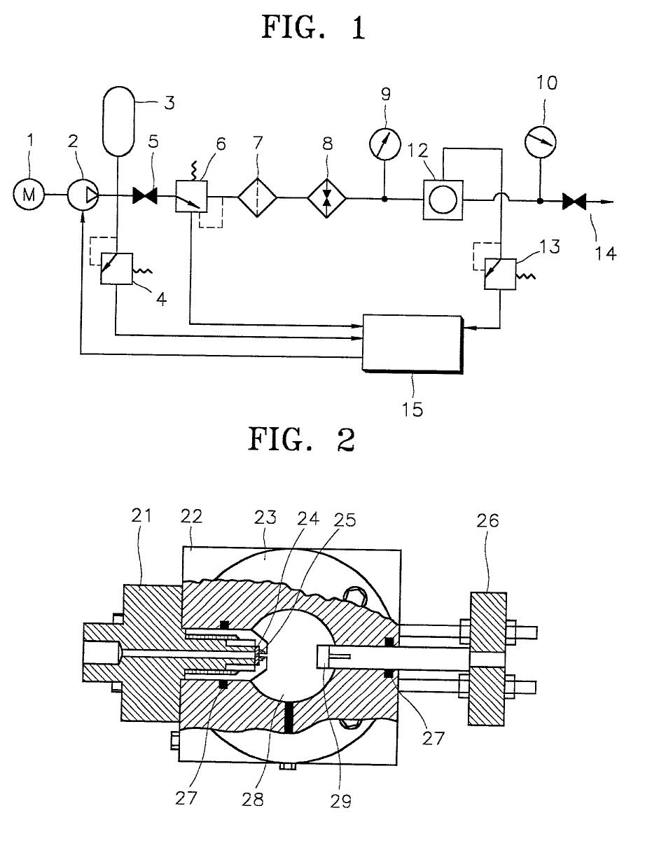

FIG. 1 is a schematic diagram of a wastewater treatment system according to an embodiment of the present invention.

The system shown in FIG. 1 includes a motor 1 for driving a water plunger pump 2, to allow water introduced from a water reservoir 15 to become pressurized at 4 to 40 MPa while passed through the plunger pump 2. The water ejected from the plunger pump 2 may be over-pressurized by 2 to 7% or may be under-pressurized by 6 to 19% comparing to the predetermined pressure. A portion of over-pressurized water passes through a first bypass throttle valve 4, and then returns to the water reservoir 15, while the remainder is stored in an accumulator 3 so that its pressure is adjusted to 4 to 40 Mpa, then to pass through the first throttle valve 5 together with the water ejected from the plunger pump 2. Here, A portion of the over-pressurized water passed through the first throttle valve 5 is passed through a high-pressure filter 7 to filter out particles or substances having a diameter of 0.4 to 1.0 mm, while the remaining over-pressurized water passed through the first throttle valve 5 is transferred to the water reservoir 15 by a second bypass throttle valve 6. The water passed through the high-pressure filter 7 passes through a heat exchanger 8 for both heating and cooling purposes so as to be adjusted to be maintained at a temperature of 5 to 25° C., and is then fed into a cavitation reactor 12 to be subjected to cavitation reaction by means of cavitation waterjet and then discharged. A portion of the over-pressurized water from upper outlet is adjusted by a third bypass throttle valve 13, then transferred to the water reservoir 15, and again the remaining water from lower outlet flows out via the second valve 14, maintaining the pressure of water discharged from the cavitation reactor in the range of 0.1-2.4 MPa.

The pressure range of the upstream water introduced to the cavitation reactor according to the present invention is adjusted to be 4 to 40 MPa according to substances to be treated. The upstream water is defined as the same that is not fed into the cavitation reactor 12, and the downstream water is also defined as the same that is discharged from the cavitation reactor 12. While the pressure of the upstream water is measured by an upper pressure gauge 9, the pressure of the downstream water is measured by a lower pressure gauge 10. The pressure of the upstream water is adjusted to be in the range of 4 to 40 MPa as indicated by the upper pressure gauge 9 using the first bypass throttle valve 4, the first throttle valve 5 and the second bypass throttle valve 6. Also, the pressure of the downstream water is adjusted to be in the range of 0.1-2.4 MPa or less as indicated by the lower pressure gauge 10 using the third bypass throttle valve 13 and the second throttle valve 14.

In order to effectively provoke a cavitation reaction in the reactor 12, the cavitation number σ represented by Formula 2 is preferably maintained in the range of 0.01 to 0.06, because the optimum cavitation bubble cloud is in this range.

According to the present invention which provides highly efficient water treatment, in order to maintain the cavitation number in the preferred range, the pressure of the upstream water is preferably adjusted in the range of 4 to 40 MPa and the pressure of the downstream water is preferably adjusted in the range of 0.1-2.4 MPa.

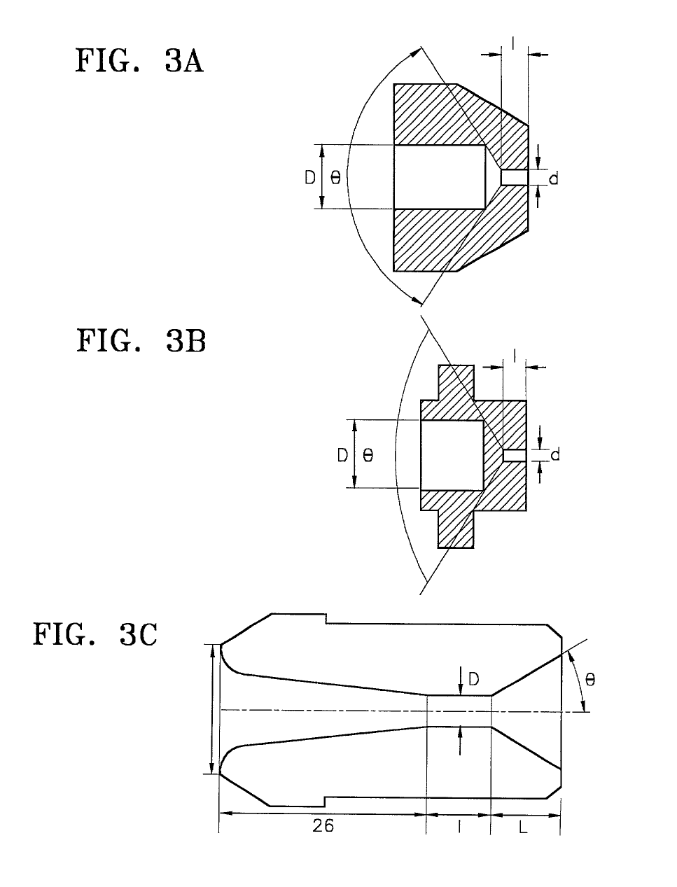

Referring to FIG. 2, a reactor is constructed such that in a state in which a nozzle 24 and a nozzle holder insert 25 are connected to a nozzle holder 21 by means of a sealant 27, the nozzle holder 21 is connected to the left side of a body 22 having a Perspex window 28 at either side thereof, and a target support 26 having a target 29 fixed at its left end is connected to the right side of the body 22 by means of another sealant 27.

The water with the pressure in the ranges of 4 to 40 MPa, introduced into the reactor via the high-pressure filter 7 and the heat exchanger 8, undergoes cavitation while impinging onto the surface of the target 29 after being ejected from the nozzle 4. During the cavitation, a cavitation bubble cloud is observed by the naked eye through the Perspex window 28 to adjust the pressure of the reactor to be 1.5 MPa or less so as to maintain an optimum cavitation bubble cloud.

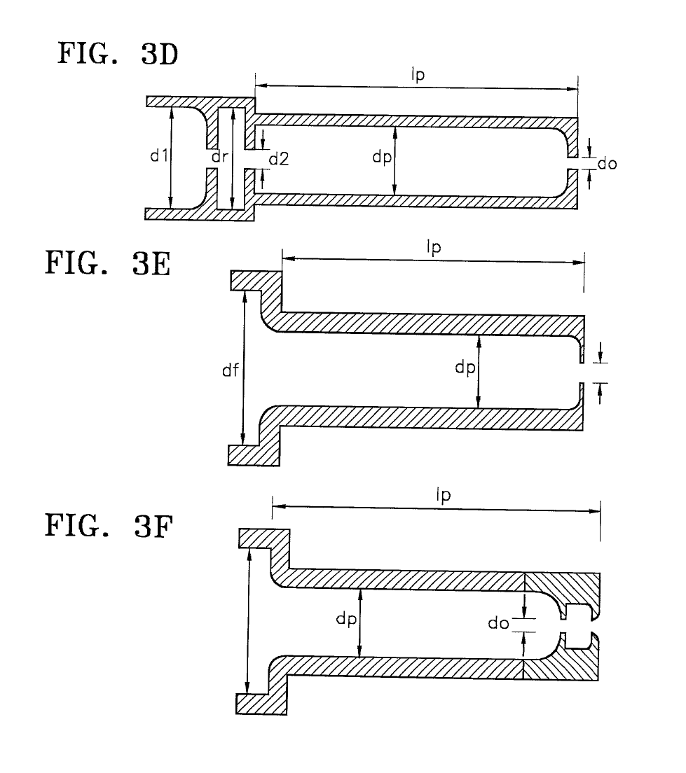

The nozzle 24 and the target 29 are preferably made of materials having wearability and strong corrosion resistance, for example, commercially available Nitronic-60 manufactured by Armco Advanced Materials Corp or SUS 304. All elements of the wastewater treatment system according to the present invention, including pumps, are preferably made of stainless steel. The shape and size of the nozzle 24 are closely related to the performance of the wastewater treatment system according to the present invention and can be appropriately selected according to target substances to be decomposed or treated, although the nozzle shown in FIG. 2 is cylindrical. For example, nozzles having various shapes are shown in FIGS. 3A through 3H.

The present invention will now be described in more detail through various examples. However, these examples may be changed or modified into different forms and the present invention should not be construed as being limited to the examples set forth herein. Rather, the examples of the present invention are provided so that this disclosure will be thorough and complete, and will fully convey the scope of the invention to those skilled in the art.

### EXAMPLE 1

### Removal of Chlorophenol Compounds

Chlorophenols used in preservation of wood are identified as dioxin generating sources. In this example, a solution containing 2,3-dichlorophenol (a first series) and 2,4-dichlorophenol (a second series), each at a concentration of 10 mg/l, was processed by the system shown in FIG. 1 for 4 cycles. Here, the upstream pressure was maintained at 20 MPa and the downstream pressure was maintained at 1.5 MPa.

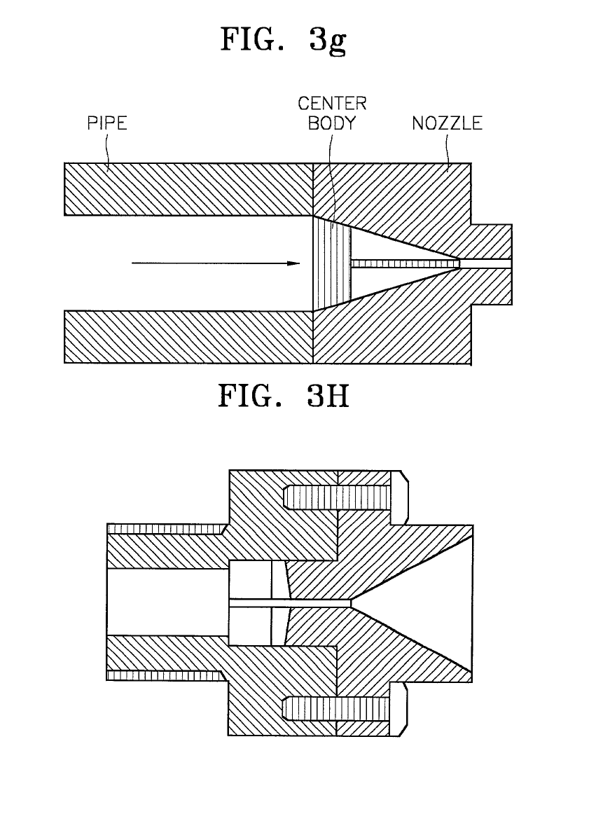

The removal efficiency is shown in FIG. 4, and referring thereto, 17% of the first series was removed and 31% of the second series was removed. A difference in removal efficiency between the first series and the second series is presumably due to the position of chlorine atom in cyclic benzene, and can be utilized as basic data concerning organic substances decomposed by cavitation jets.

### EXAMPLE 2

### Removal of Biphenyl

Polychlorobiphenyls (PCBs) known as substituted biphenyl compounds which are environmental endocrine distruptors (EEDs) are restricted as materials that should not be detected in water in quality criteria for water. In this example, 5 mg/l of a solution obtained by dissolving biphenyl used as a source material in a mixed solvent of water and ethyl alcohol was injected into the system shown in FIG. 1 for decomposition. Here, the upstream pressure was maintained at 15 MPa and the downstream pressure was maintained at 1.5 MPa.

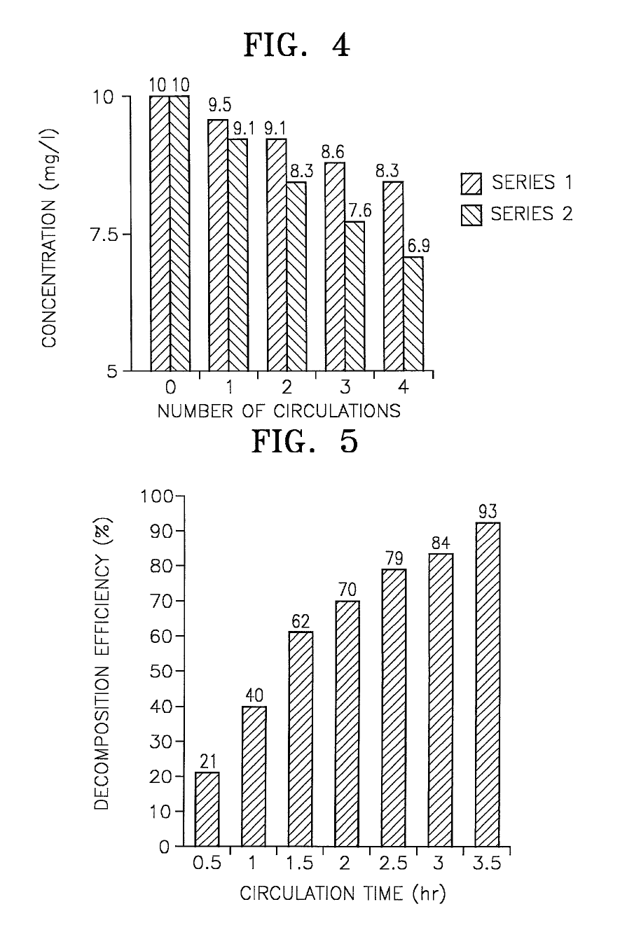

As shown in FIG. 5, more than 62% of the biphenyl was decomposed after approximately 1.5 hours and approximately 93% of biphenyl was removed after 3.5 hours.

### EXAMPLE 3

### Removal of Trichloroethylene

Organic solvents contained in wastewater from electronics factories, e.g., trichloroethylene, tetrachloroethylene or trichloroethane, are known to cause cancer if only a trace amount is absorbed into the human body over a long period. In this example, trichloroethylene was subjected to decomposition tests. A test solution (0.25 mg/l) was obtained by agitating wastewater for more than 8 hours and sealed with a Teflon tape to minimize evaporation loss. Here, the upstream pressure was maintained at 30 MPa and the downstream pressure was maintained at 1.5 MPa.

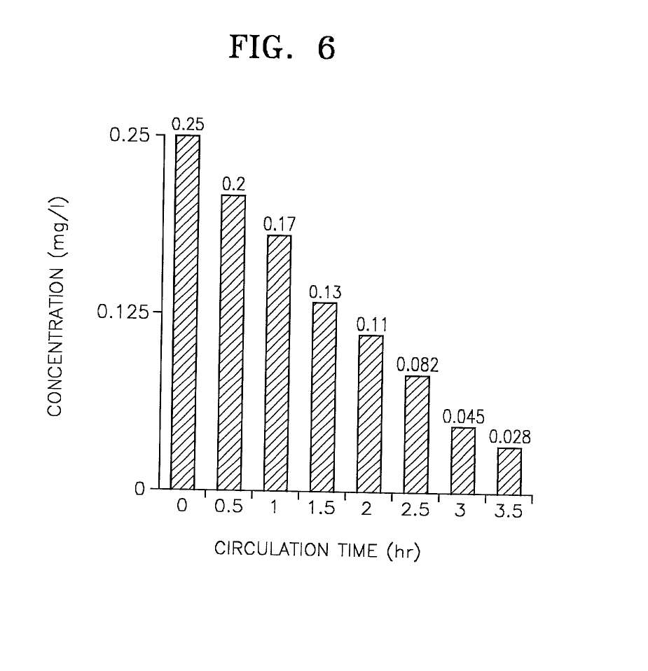

As shown in FIG. 6, approximately 89% of the trichloroethylene was removed after 3.5 hours of circulation, and it was ascertained that the content of trichloroethylene was reduced to less than the quality criteria level for groundwater or minimum exhaust criteria (0.06 mg/l).

### EXAMPLE 4

### Collapse of Coliforms

In order to reduce harm don by waterborne coliforms or parasites which considerably adversely affect the productivity of fish-farms and hatcheries, a large amount of formalin is being used. Moreover, formalin is known to be a carcinogen. In this example of the present invention that provides a new method of collapsing coliforms removing diatoms, flagellates, toxic plankton and other red tide microorganisms frequently appearing in coastal areas and freshwater lakes in Korea every year, coliforms in river water were subjected to sterilization tests using the system shown in FIG. 1. Here, the upstream pressure was maintained at 40 MPa and the downstream pressure was maintained at 1.5 MPa.

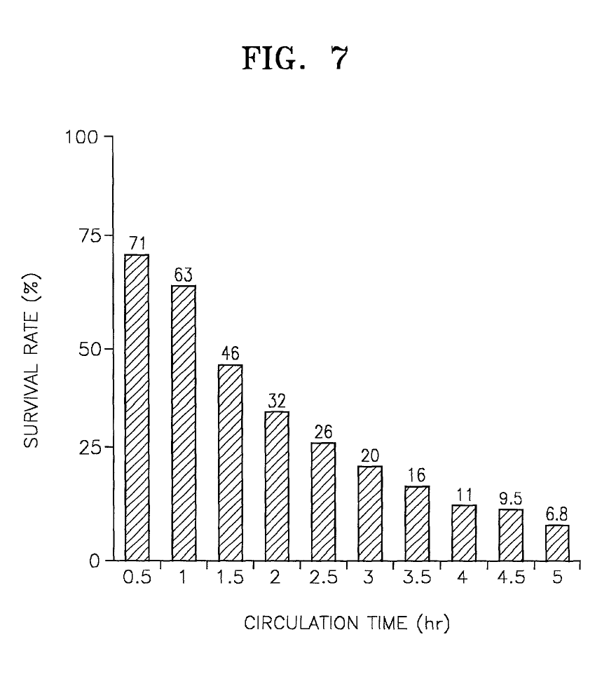

As shown in FIG. 7, sterilization using cavitation jets is rapidly performed within a short period from an initial stage to 1.5 hours after initialization of the circulation and sterilization. During the period, approximately 54% of the coliforms were collapsed and most of the coliforms were sterilized after 5 hours.

Also, according to the present invention, the content of ammoniacal nitrogen can be reduced from 13 ppb to 6 ppb within 2 hours after starting circulation, using cavitation jets of 40 MPa or less, while increasing a pH from 7.5 to 8.2, thus improving the environment and chances for survival of fish and other aquatic animals.

According to the present invention, various kinds of environmentally harmful organic substances such as dioxins and water microorganisms such as viruses, coliforms or toxic algaes can be effectively destroyed or decomposed using radicals, ultrahigh shock waves and ultrahigh-pressure microjets through oxidation, decomposition, erosion and cutting, just by injecting wastewater to be treated into a cavitation jet reactor without using any additives. The present invention has the following advantages.

First, organic contaminants and water microorganisms can be easily decomposed and sterilized without causing any secondary problems such as an unpleasant smell, toxicity arising due to residual chlorine during sterilization of potable water. Also, a decrease in the concentration of carbon dioxide, which is caused by the generation of a cavitation bubble cloud, can increase the pH level. Further, high-viscosity organic contaminants can be easily decomposed by the radicals, ultrahigh shock waves and ultrahigh-pressure microjets, thereby preventing a reduction in the filtering speed due to the generation of a filtering-prevention layer.

Second, various kinds of microorganisms including water parasites and coliforms and wastewater contaminated by organic substances such as fish-luring agents are altogether injected into a cavitation jet reactor to be indiscriminately destroyed and sterilized, without using a carcinogenic sterilizer, e.g., formalin, or other chemicals which are used in existing fish-farms or nurseries. Also, a decrease in the concentration of dissolved carbon dioxide due to generation of a cavitation bubble cloud increases a pH level, so that lime needs not to be added. Therefore, the wastewater treatment method using cavitating jets according to the present invention can effectively improve the survival environments of fish without harming fish, for example, loosing their scales or damage to their internal organs.

Third, diatoms, flagellates and toxic plankton causing sitotoxism by poisoning shellfishes and the like, and red tide microorganisms such as water parasites and coliforms which cause severe damage in coastal areas and freshwater lakes in some countries every year, can be selectively decomposed and sterilized. Also, a decrease in the concentration of dissolved carbon dioxide due to generation of a cavitation bubble cloud makes it possible to decompose and remove hazardous organic contaminants and water microorganisms, and to realize a clean marine ecosystem easily at low cost, without impeding the respiration of fish with lime.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A wastewater treatment system comprising a cavitation reactor including an inlet into which wastewater is introduced, a main body in which a cavitation reaction occurs to treat the wastewater, and an outlet from which the treated wastewater is discharged, the main body comprising a nozzle for ejecting the introduced wastewater and a target with which the ejected wastewater collides.

2. The wastewater treatment system according to claim 1, further comprising a waterjet pump for pressurizing the wastewater and supplying the pressurized wastewater to the inlet of the cavitation reactor.

3. The wastewater treatment system according to claim 2, wherein the waterjet pump is a plunger-type pump or an intensifier-type pump.

4. The wastewater treatment system according to claim 2, wherein the pressure of the wastewater ejected from the waterjet pump is maintained at 4 to 40 MPa.

5. The wastewater treatment system according to claim 2, further comprising a first bypass throttle valve for bypassing a portion of the pressurized wastewater to depressurize the pressurized wastewater.

6. The wastewater treatment system according to claim 2, further comprising a first throttle valve for adjusting the amount of the pressurized wastewater ejected from the waterjet pump and supplied to the inlet of the cavitation reactor.

7. The wastewater treatment system according to claim 1, further comprising a filter for removing solid impurities larger than a predetermined size contained in the wastewater.

8. The wastewater treatment system according to claim 1, further comprising a heat exchanger for maintaining the wastewater at a predetermined temperature.

9. The wastewater treatment system according to claim 1, further comprising a second throttle valve for adjusting the amount of the wastewater discharged from the outlet of the cavitation reactor.

10. The wastewater treatment system according to claim 2, further comprising a second bypass throttle valve for bypassing a portion of the pressurized wastewater.

11. The wastewater treatment system according to claim 1, further comprising a third bypass throttle valve for controlling the pressure of the treated wastewater discharged from the outlet of the cavitation reactor.

12. The wastewater treatment system according to claim 6, further comprising an accumulator for storing the wastewater ejected from the waterjet pump to adjust the pressure of the same, between the waterjet pump and the first throttle valve.

13. The wastewater treatment system according to claim 1, further comprising a first pressure gauge for measuring the pressure of the wastewater which flows into the inlet of the cavitation reactor.

14. The wastewater treatment system according to claim 1, further comprising a pressure adjusting means for adjusting the pressure of the water introduced into the inlet of the cavitation reactor to be maintained at 4 to 40 MPa.

15. The wastewater treatment system according to claim 1, wherein the pressure of the treated wastewater discharged from the outlet of the cavitation reactor is adjusted to be maintained at 0.1 to 2.4 MPa.

16. The wastewater treatment system according to claim 1, further comprising a second pressure gauge for measuring the pressure of the treated wastewater discharged from the outlet of the cavitation reactor.

17. A method of treating wastewater comprising:
introducing wastewater into a reactor; and
ejecting the wastewater toward a target disposed in the reactor to generate cavitation reaction.

18. The method according to claim 17, further comprising pressurizing the wastewater before the introducing.

19. The method according to claim 18, wherein the pressure of the wastewater is maintained at 4 to 40 MPa.

20. The method according to claim 17, further comprising removing solid impurities larger than a predetermined size contained in the water.

21. A wastewater treatment method comprising provoking a cavitation reaction to treat wastewater by ejecting the wastewater to a cavitation reactor having an inlet into which wastewater is introduced, a main body in which a cavitation reaction occurs to treat the wastewater, and an outlet from which the treated water is discharged.
